(19) United States
(12) Patent Application Publication
(10) Pub. No.: US 2018/0186642 A1
(43) Pub. Date: Jul. 5, 2018

(54) PRECURSOR SLURRY OF BATTERY COMPOSITE MATERIAL AND PREPARATION METHOD OF BATTERY COMPOSITE MATERIAL

(71) Applicant: TATUNG FINE CHEMICALS CO., Taoyuan City (TW)

(72) Inventor: Chien-Min Chang, Taoyuan City (TW)

(73) Assignee: TATUNG FINE CHEMICALS CO., Taoyuan City (TW)

(21) Appl. No.: 15/715,178

(22) Filed: Sep. 26, 2017

(30) Foreign Application Priority Data
Dec. 29, 2016 (TW) 105143853

(51) Int. Cl. C01B 25/45; C01B 32/05; H01M 4/04; H01M 10/0525

(52) U.S. Cl. CPC C01B 25/45; C01B 32/05; C01P 2006/40; H01M 10/0525; H01M 4/04

(57) ABSTRACT

A preparation method of a battery composite material includes steps as follows. A phosphoric acid solution, a zerovalent iron and a catalyst are mixed and undergoing an oxidation reaction to generate a precursor slurry including a compound of formula (1). The precursor slurry, a first component, and a second component are mixed and reacted to generate a resultant. The resultant is powderized. Then powderized resultant is calcined to produce a composite material represented by the following formula (2).

Fe₂P₂O₇ formula (1)

LiFePO₄/C(s) formula (2)

### CROSS-REFERENCE TO RELATED APPLICATION

This application claims the priority benefit of Taiwan application serial no. 105143853, filed on Dec. 29, 2016. The entirety of the above-mentioned patent application is hereby incorporated by reference herein and made a part of this specification.

### TECHNICAL FIELD

The invention relates to a technology of lithium battery; and more particularly relates to a precursor slurry of a battery composite material and a preparation method of a battery composite material.

### BACKGROUND

For power batteries, such as a lithium-ion battery, lithium iron phosphate (LFP) is a common material serving as a cathode material of a battery in recent years. Specifically, the mass production of the lithium iron phosphate is mostly done by solid-state reaction method or solution method. However, for a high C rate test (a rapid charge/discharge test), a specific capacity of the lithium iron phosphate obtained by the solid-state reaction method is less as comparing to the expected value. On the other hand, although the lithium iron phosphate obtained by the solution method has a higher specific capacity at high C rate, a much longer reaction time and higher manufacturing cost are required. Yet, as the reaction time is getting longer, other undesirable reactions are very likely to occur in the synthesis process of the lithium iron phosphate, and impurities such as iron oxide and iron(III) oxide-hydroxide (Fe(OH)₃) are generated, and thereby reducing specific capacity thereof.

Therefore, there is a need for a method capable of preparing a battery composite material having a high specific capacity measured at high C rate.

### SUMMARY

The invention provides a precursor slurry of a battery composite material having smaller mean particle diameter, which can increase the specific capacity of the battery composite material prepared with the precursor slurry.

The invention also provides a preparing method of a battery composite material, which is capable of obtaining a battery composite material of high specific capacity and better rate capability.

The precursor slurry of the battery composite material of the invention includes a compound represented by formula (1),

Fe₂P₂O₇ formula (1),

wherein the precursor slurry is prepared by an oxidation reaction of a mixture of a phosphoric acid aqueous solution, a zero-valent iron and a catalyst.

In an embodiment of the invention, a mean particle diameter of the precursor slurry is less than 10 micrometers (μm).

In an embodiment of the invention, a molarity of the phosphoric acid aqueous solution is between 0.1 M and 10 M.

In an embodiment of the invention, a morphology of the zero-valent iron includes a plate shape, a solid spherical shape, a porous structure, or a combination thereof.

In an embodiment of the invention, the catalyst includes metals or metal oxides.

In an embodiment of the invention, the catalyst includes vanadium pentoxide (V₂O₅).

In an embodiment of the invention, based on a total amount of the precursor slurry, a content of the phosphoric acid aqueous solution in the precursor slurry is between 70 wt % and 90 wt %, a content of the zero-valent iron in the precursor slurry is between 1 wt % and 27 wt %, and a content of the catalyst in the precursor slurry is between 0.001 wt % and 3 wt %.

In an embodiment of the invention, a content of the catalyst is about 0.1% to 10% of a content of the zero-valent iron.

The preparing method of a battery composite material of the invention includes steps as follow. A phosphoric acid aqueous solution, a zero-valent iron and a catalyst are mixed and then undergo an oxidation reaction to generate a precursor slurry including a compound represented by formula (1). A first component, a second component and the precursor slurry are mixed and reacted to generate a resultant. The resultant is powderized. The powderized resultant is calcined to produce a composite material represented by formula (2).

Fe₂P₂O₇ formula (1),

LiFePO₄/C₍ₛ₎ formula (2).

In an embodiment of the invention, the resultant is powderized by a spray drying treatment.

In an embodiment of the invention, the powderized resultant is calcined under an inert gas environment.

In an embodiment of the invention, a molarity of the phosphoric acid aqueous solution is between 0.1 M and 10 M.

In an embodiment of the invention, a morphology of the zero-valent iron includes a plate shape, a solid spherical shape, a porous structure, or a combination thereof.

In an embodiment of the invention, the catalyst includes metals or metal oxides.

In an embodiment of the invention, a mean particle diameter of the precursor slurry is less than 10 micrometers (μm).

In an embodiment of the invention, based on a total amount of the precursor slurry, a content of the phosphoric acid aqueous solution in the precursor slurry is between 70 wt % and 90 wt %, a content of the zero-valent iron in the precursor slurry is between 1 wt % and 27 wt %, and a content of the catalyst in the precursor slurry is between 0.001 wt % and 3 wt %.

In an embodiment of the invention, a content of the catalyst is about 0.1% to 10% of a content of the zero-valent iron.

In an embodiment of the invention, the first component includes lithium hydroxide, lithium carbonate, or a combination thereof.

In an embodiment of the invention, the second component includes carbon-based materials, organic compounds having a molecular weight less than 10,000, organic compounds having a molecular weight greater than 10,000, or a combination thereof.

In an embodiment of the invention, based on 100 parts by weight of the precursor slurry, an amount of the first component ranges from 0.4 parts by weight to 20.8 parts by weight, and an amount of the second component ranges from 0.01 parts by weight to 15 parts by weight.

Based on the above, a catalyst is added into the precursor slurry of a battery composite material in the invention to improve a refinement of the mean particle diameter of the precursor slurry, the reaction time of the precursor slurry of a battery composite material can be shorten. Accordingly, the generated amount of the impurities (such as iron oxide and iron(III) oxide-hydroxide (Fe(OH)₃), etc.) that decreasing specific capacity can be reduced. In addition, the catalyst used in the invention can be used as a dopant in the precursor slurry to enhance the specific capacity of a composite material subsequently generated. Therefore, in a high C rate test, a battery, which has a positive electrode made of a composite material formed by the preparing method of a battery composite material of the invention, has a high specific capacity and a good rate capability.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 schematically illustrates the flow chart of a preparing method of a battery composite material according to an embodiment of the invention.

FIG. 2 is a comparison diagram of an X-ray diffraction (XRD) pattern of a battery composite material in an experimental example of the invention and an XRD pattern of a pure lithium iron phosphate.

FIG. 3 is a comparison diagram of an XRD pattern of a precursor slurry (after powderizing and calcining) of the battery composite material in the experimental example and an XRD pattern of a pure ferrous pyrophosphate.

FIG. 4 is a curve diagram of particle diameter distribution of the battery composite material in the experimental example.

FIG. 5 is a curve diagram of particle diameter distribution of a battery composite material generated in a comparative example.

FIG. 6 is a charge/discharge curve of the battery composite material in the experimental example at different charge/discharge rates.

FIG. 7 is a charge/discharge curve of the battery composite material in the comparative example at different charge/discharge rates.

### DESCRIPTION OF THE EMBODIMENTS

In the specification, scopes represented by “a numerical value to another numerical value” are schematic representations in order to avoid listing all of the numerical values in the scopes in the specification. Therefore, the recitation of a specific numerical range covers any numerical value in the numerical range and a smaller numerical range defined by any numerical value in the numerical range, as is the case with any numerical value and a smaller numerical range thereof in the specification.

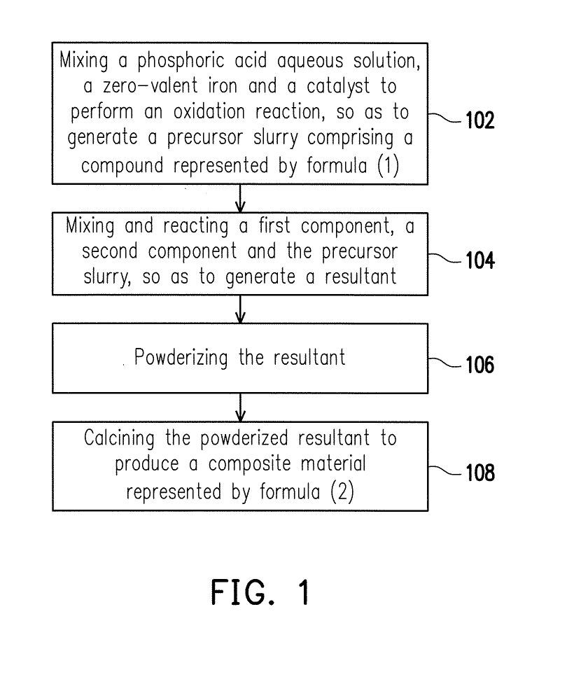

FIG. 1 schematically illustrates the flow chart of a preparing method of a battery composite material according to an embodiment of the invention.

Referring to FIG. 1, in step 102, a phosphoric acid aqueous solution, a zero-valent iron and a catalyst are mixed and then undergo an oxidation reaction to generate a precursor slurry including a compound represented by formula (1).

Fe₂P₂O₇ formula (1)

In an embodiment, based on a total amount of the precursor slurry, a content of the phosphoric acid aqueous solution in the precursor slurry is between 70 wt % and 90 wt %, a content of the zero-valent iron in the precursor slurry is between 1 wt % and 27 wt %, and a content of the catalyst in the precursor slurry is between 0.001 wt % and 3 wt %. In an embodiment of the invention, a content of the catalyst is about 0.1% to 10% of a content of the zero-valent iron. In an embodiment of the invention, a mean particle diameter of the precursor slurry is less than 10 μm.

In the embodiment, mixing the phosphoric acid aqueous solution, the zero-valent iron and the catalyst to perform an oxidation reaction includes the following steps. Firstly, the phosphoric acid aqueous solution, the zero-valent iron and the catalyst are prepared by precise weighting according to stoichiometry; and sequentially, based on the need, reaction temperature and stirring speed is properly adjusted to synthesize a precursor slurry as demanded. The zero-valent iron is oxidized to a divalent iron ion (e.g. Fe²⁺) in the phosphoric acid aqueous solution for sequential bonding, and in addition, a reaction rate between the zero-valent iron and the phosphoric acid aqueous solution is accelerated and the degree of a size refinement (e.g. reduction in the size dimension) of the zero-valent iron is promoted by adding the catalyst, so as to form the precursor slurry of the invention. It is worth noting that the catalyst is also served as a dopant in the precursor slurry, such that the specific capacity of the composite material prepared with the precursor slurry is increased.

In an embodiment of the invention, a molarity of the phosphoric acid aqueous solution is, for instance, between 0.1 M and 10 M, preferably between 0.5 M and 5 M. In an embodiment of the invention, the zero-valent iron, for instance, includes iron metal in solid state, which may be in form of bulk, sheet or powder. In an embodiment of the invention, a morphology of the zero-valent iron, for instance, includes a plate shape, a solid spherical shape, a porous structure, or a combination thereof. In an embodiment of the invention, the catalyst includes metals or metal oxides. For exemplary, in one embodiment, the catalyst may include vanadium pentoxide (V₂O₅) for accelerating the reaction rate between the zero-valent iron and the phosphoric acid aqueous solution and promoting the degree of the size refinement of the zero-valent iron. Note that, the vanadium pentoxide is dissolved in the phosphoric acid aqueous solution but does not react with the zero-valent iron, wherein vanadium ions of the vanadium pentoxide are served as a dopant in the precursor slurry, such that the specific capacity of the composite material prepared with the precursor slurry is increased. In an embodiment of the invention, the reaction temperature is ranging from 20° C. to 70° C., and the stirring speed is about 500 rpm to 3000 rpm (rotations per minute).

Referring to FIG. 1, in step 104, a first component, a second component and the precursor slurry are mixed and reacted to generate a resultant. In an embodiment of the invention, based on 100 parts by weight of the precursor slurry, an amount of the first component ranges from 0.4 parts by weight to 20.8 parts by weight, and an amount of the second component ranges from 0.01 parts by weight to 15 parts by weight.

In the embodiment, mixing the first component, the second component and the precursor slurry includes preparing the first component, the second component and the precursor slurry by precise weighting according to stoichiometry; and sequentially, based on the need, reaction temperature and stirring speed is properly adjusted to synthesize a resultant as demanded. In an embodiment of the invention, the first component is a lithium ion-containing precursor, and the first component, for example, includes lithium hydroxide, lithium carbonate, or a combination thereof. In an embodiment of the invention, the second component is a carbon-containing precursor, and the second component, for example, includes carbon-based materials (such as acetylene black, carbon nanotubes, graphene, etc.), organic compounds having a molecular weight less than 10,000 (such as sucrose, lactose, glucose, etc.), organic compounds having a molecular weight greater than 10,000 (such as polyvinyl alcohol (PVA), polyethylene glycol (PEG), epoxy resin, etc.), or a combination thereof. In an embodiment of the invention, the reaction temperature is ranging from 20° C. to 70° C., and the stirring speed is about 500 rpm to 3000 rpm.

Referring to FIG. 1, in step 106, the resultant is powderized (e.g. the resultant in a liquid state is transformed into dry powder, i.e., a solid state). In an embodiment of the invention, the resultant is powderized by a spray drying treatment. In one embodiment, the spray drying treatment is, for example, performed via a spray drying device, wherein the processing conditions, for examples, include an environment pressure of about 1 atmosphere (atm), a rotation speed of about 20,000 rpm to 22,000 rpm, and an operation temperature of about 190° C. to 220° C., however the invention is not limited thereto.

Referring to FIG. 1, in step 108, the powderized resultant is calcined to produce a composite material represented by formula (2).

LiFePO₄/C₍ₛ₎ formula (2).

In an embodiment of the invention, the powderized resultant is calcined under an atmosphere of inert gases (e.g., an inert gas environment) at a calcined temperature of 400° C. to 1000° C. for 1 hour to 20 hours (a time for calcining). In one embodiment, the inert gases, for example, include argon gas or nitrogen gas, and the calcining time is, for example, preferably from 4 hours to 16 hours.

Furthermore, in one embodiment, a solvent is optionally added into the mixture of the phosphoric acid aqueous solution, the zero-valent iron and the catalyst in step 102 for adjusting the viscosity of the precursor slurry, but does not react with the phosphoric acid aqueous solution, the zero-valent iron, the catalyst, the first component, and the second component. The invention does not particularly limit the type of the solvent.

An exemplary experiment is provided below to verify the effect of the battery composite material made by the preparing method of the battery composite material of the invention, but the scope of the invention is not limited thereto.

<Starting Materials>

Phosphoric acid aqueous solution: 3 M phosphoric acid aqueous solution (manufactured by Yeou Yuan Trading CO., Ltd.)

Zero-valent iron: powdery zero-valent iron having a surface of porous structure (manufactured by Hoganas Taiwan Ltd.)

Catalyst: V₂O₅ powder (manufactured by Sigma-Aldrich Co., Ltd)

First component: lithium hydroxide powder (manufactured by Sigma-Aldrich Co., Ltd.)

Second component: 15% PVA aqueous solution (manufactured by First Chemical Manufacture Co., Ltd.)

Solvent: pure water

### Experimental Example

500 grams of 3 M phosphoric acid aqueous solution, 1.3 grams of V₂O₅ powder, and 83.7 grams of powdery zero-valent iron were prepared by precisely weighting according to stoichiometry and placed in a 2,000 milliliter (mL) beaker, and then were mixed and reacted via a mechanical stirrer to generate a precursor slurry. The stirring speed was about 500 rpm to 1,500 rpm, the stirring temperature was about 20° C. to 70° C., and the time for stirring was about 3 hours. 300 mL of pure water were added into the precursor slurry and stirred for 24 hours. 63.0 grams of lithium hydroxide and 39.5 grams of 15% PVA aqueous solution were prepared by precisely weighting according to stoichiometry and then were added into the beaker to mix and react with the precursor slurry to generate a resultant. The stirring speed was about 500 rpm to 1,000 rpm, the stirring temperature was about 20° C. to 70° C., and the time for stirring was about 1˜5 hours. Then, the resultant was evenly mixed and then powderized by spray drying via a spray drying device, wherein the processing conditions, for example, included an environment pressure of 1 atm, a rotation speed of about 20,000 rpm to 22,000 rpm, an inlet operation temperature of about 190° C. to 220° C., and an outlet operation temperature of about 75° C. to 95° C. Finally, the powderized resultant was calcined to produce a final product, a powdery composite material: LiFePO₄/C₍ₛ₎, under an atmosphere of nitrogen gas, wherein the calcining temperature was about 800° C., and the calcining time was about 8 hours.

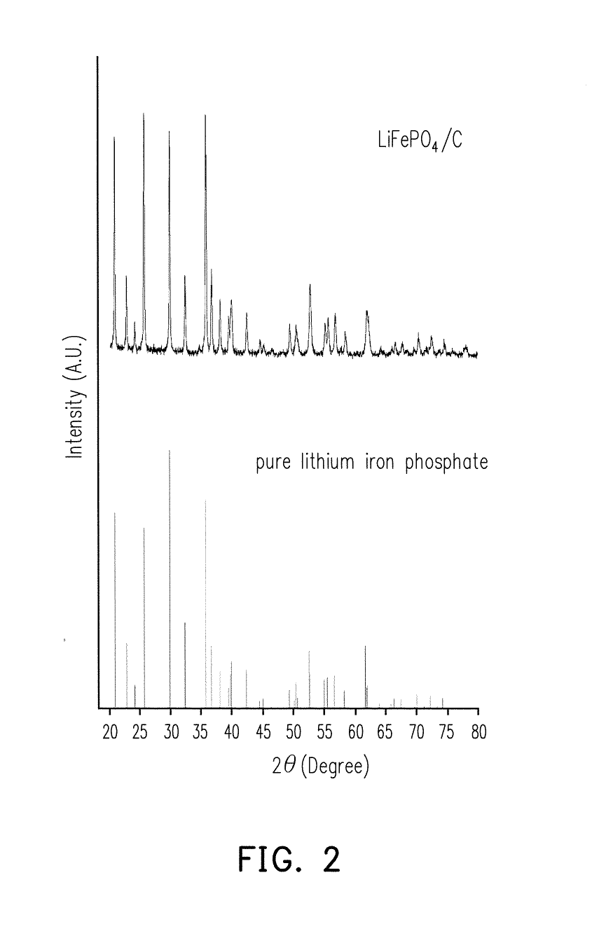

The product of the experimental example is examined with X-ray diffraction (XRD) analysis and compared to a XRD pattern of a pure lithium iron phosphate, and thus FIG. 2 is obtained. According to FIG. 2, the product of the experimental example is confirmed to be a compound represented by formula (2),

LiFePO₄/C₍ₛ₎ formula (2).

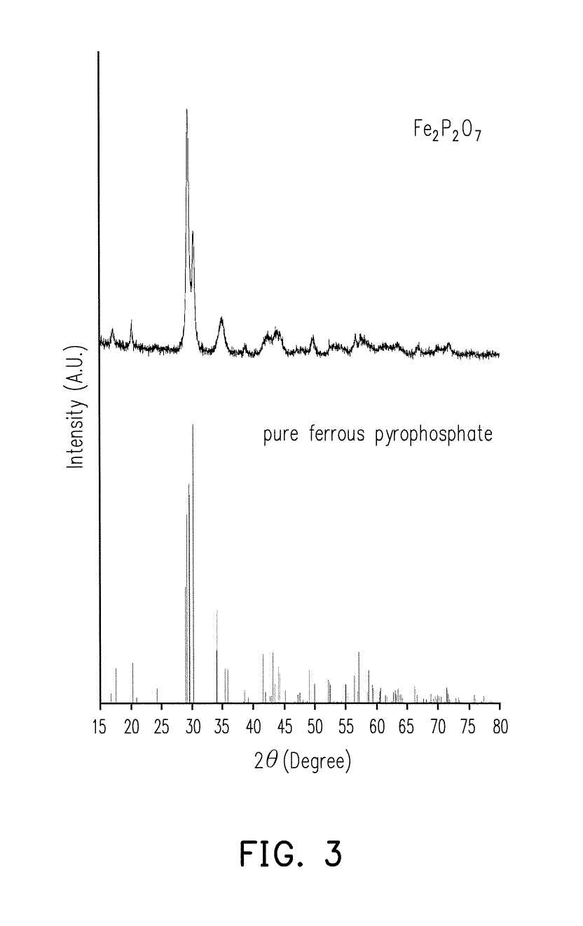

The precursor slurry of the experimental example is further processed by spray drying treatment (at an environment pressure of 1 atm, a rotation speed of about 20,000 rpm to 22,000 rpm, an inlet operation temperature of about 190° C. to 220° C., and an outlet operation temperature of about 75° C. to 95° C.) and thermal treatment (a calcining temperature of about 800° C., a calcining time of about 8 hours, and under a nitrogen gas environment), and then is examined with XRD analysis and compared to a XRD pattern of a pure ferrous pyrophosphate, and thus FIG. 3 is obtained. According to FIG. 3, the precursor slurry of the experimental example is confirmed for having a compound represented by formula (1),

Fe₂P₂O₇ formula (1).

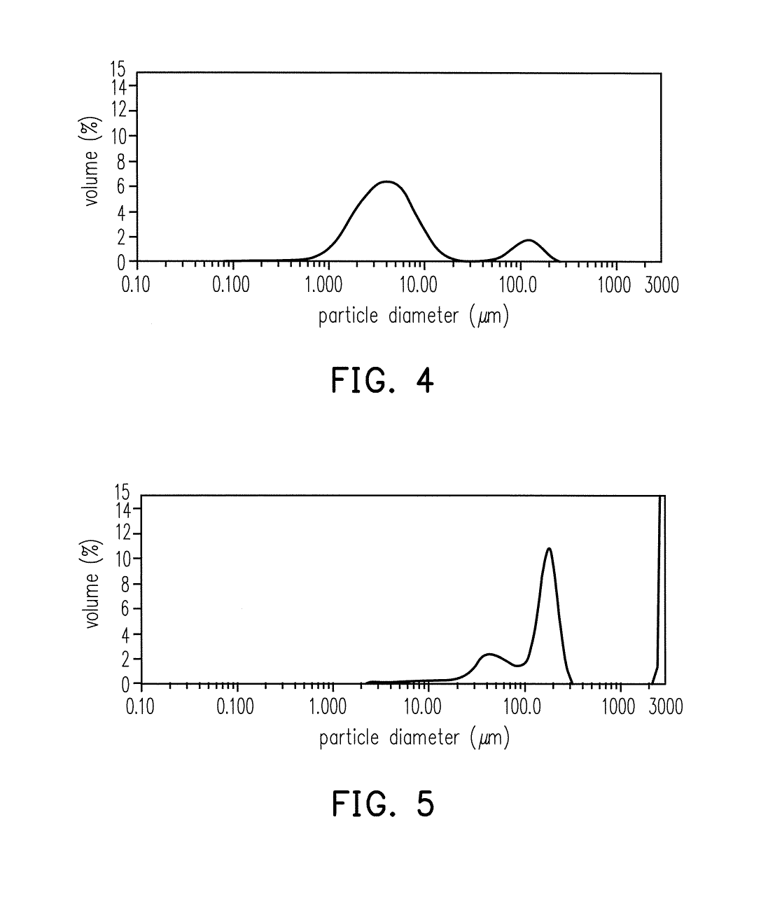

The precursor slurry of the experimental example is examined with dynamic light scattering (DLS) analysis, the result is shown in FIG. 4. According to FIG. 4, the precursor slurry of the experimental example has a mean particle diameter less than 10 μm.

### Comparative Example

A precursor slurry of the comparative example was prepared according to a preparing process of the experimental example, but no V₂O₅ powder (e.g., the catalyst) was used to prepare the precursor slurry of the comparative example.

The precursor slurry of the comparative example is examined with DLS analysis, the result is shown in FIG. 5. According to FIG. 5, the precursor slurry of the experimental example has a mean particle diameter of about 200 μm.

In view of above, in the invention, the catalyst is added into the precursor slurry for preparing the battery composite material, which improves the refinement of the mean particle diameter of the precursor slurry and has shorten the reaction time of the precursor slurry of the battery composite material. Accordingly, the generated amount of the impurities (such as iron oxide and iron(III) oxide-hydroxide (Fe(OH)₃), etc.) that decreasing specific capacity can be reduced.

<Evaluation Method>

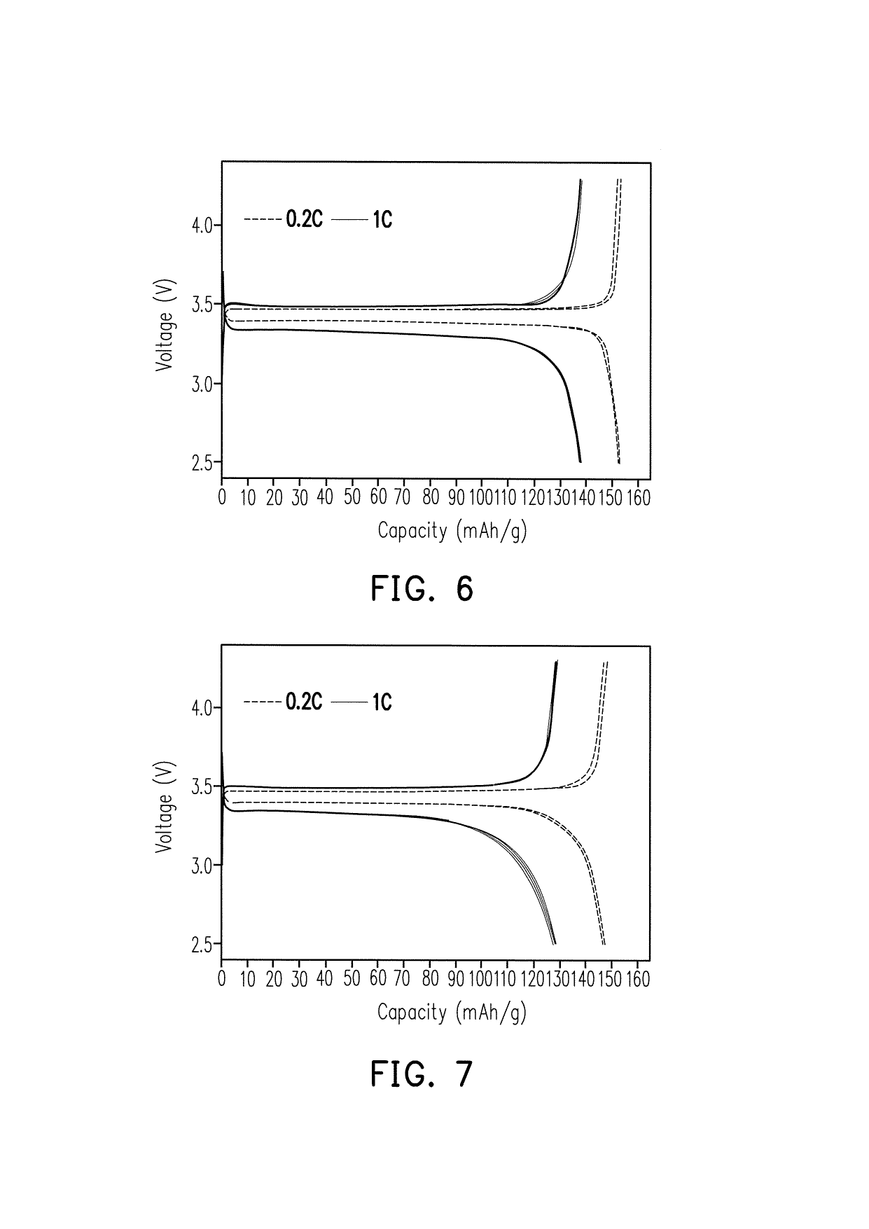

A coin cell (size CR2032) assembled in an argon-filled glove box having the moisture and oxygen content less than 1 ppm is used as the device of a test material, wherein a negative electrode is a lithium metal, and the electrolyte solution is 1.0 M of LiPF₆ in a mixture of ethylene carbonate (EC)-propylene carbonate (PC)-diethyl carbonate (DEC) with a volume ratio EC/PC/DEC=1:1:1. The composite material in the experimental example and the composite material in the comparative example are respectively used as the positive electrode of one coin cell, and a charge/discharge test at different charge/discharge rates is conducted, and results thereof are shown in FIG. 6 and FIG. 7, respectively.

FIG. 6 shows a charge/discharge curve of the coin cell using the composite material in the experimental example as the positive electrode at different charge/discharge rates. FIG. 7 shows a charge/discharge curve of the coin cell using the composite material in the comparative example as the positive electrode at different charge/discharge rates.

Referring to FIG. 6, with a charge/discharge rate of 0.2 C (low rate), the coin cell using the composite material in the experimental example as the positive electrode has a specific capacity of 152 mAh/g; and with a charge/discharge rate of 1 C (high rate), the coin cell using the composite material in the experimental example as the positive electrode has a specific capacity of 139 mAh/g. On the other hand, referring to FIG. 7, with a charge/discharge rate of 0.2 C (low rate), the coin cell using the composite material in the comparative example as the positive electrode has a specific capacity of 149 mAh/g; and with a charge/discharge rate of 1 C (high rate), the coin cell using the composite material in the comparative example as the positive electrode has a specific capacity of 129 mAh/g. According to FIG. 6 and FIG. 7, the coin cell using the composite material in the experimental example as the positive electrode shows a high specific capacity and a better rate capability.

Based on the above, in the invention, the catalyst is added into the precursor slurry of a battery composite material to improve the refinement of mean particle diameter of the precursor slurry and to reduce the reaction time of the precursor slurry of a battery composite material. Accordingly, the generated amount of the impurities (such as iron oxide and iron(III) oxide-hydroxide (Fe(OH)₃), etc.) that decreasing specific capacity is reduced. Moreover, the catalyst used in the invention can be used as a dopant in the precursor slurry to enhance the specific capacity of a composite material subsequently generated. Therefore, in a high C rate test, a battery having a positive electrode made of a composite material formed by the preparing method of a battery composite material of the invention has a high specific capacity and a good rate capability.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A precursor slurry of a battery composite material, comprising:
a compound represented by formula (1),
Fe₂P₂O₇ formula (1),
wherein the precursor slurry is prepared by an oxidation reaction of a mixture of a phosphoric acid aqueous solution, a zero-valent iron and a catalyst.

2. The precursor slurry of claim 1, wherein a mean particle diameter of the precursor slurry is less than 10 μm.

3. The precursor slurry of claim 1, wherein a molarity of the phosphoric acid aqueous solution is between 0.1 M and 10 M.

4. The precursor slurry of claim 1, wherein a morphology of the zero-valent iron comprises a plate shape, a solid spherical shape, a porous structure, or a combination thereof.

5. The precursor slurry of claim 1, wherein the catalyst comprises metals or metal oxides.

6. The precursor slurry of claim 5, wherein the catalyst comprises vanadium pentoxide.

7. The precursor slurry of claim 1, wherein based on a total amount of the precursor slurry, a content of the phosphoric acid aqueous solution in the precursor slurry is between 70 wt % and 90 wt %, a content of the zero-valent iron in the precursor slurry is between 1 wt % and 27 wt %, and a content of the catalyst in the precursor slurry is between 0.001 wt % and 3 wt %.

8. The precursor slurry of claim 7, wherein the content of the catalyst is about 0.1% to 10% of the content of the zero-valent iron.

9. A preparing method of a battery composite material, comprising:
mixing a phosphoric acid aqueous solution, a zero-valent iron and a catalyst to perform an oxidation reaction, so as to generate a precursor slurry comprising a compound represented by formula (1);
mixing and reacting a first component, a second component and the precursor slurry, so as to generate a resultant;
powderizing the resultant; and
calcining the powderized resultant to produce a composite material represented by formula (2),
Fe₂P₂O₇ formula (1),
LiFePO₄/C₍ₛ₎ formula (2).

10. The preparing method of claim 9, wherein the resultant is powderized by a spray drying treatment.

11. The preparing method of claim 9, wherein the powderized resultant is calcined under an inert gas environment.

12. The preparing method of claim 9, wherein a molarity of the phosphoric acid aqueous solution is between 0.1 M and 10 M.

13. The preparing method of claim 9, wherein a morphology of the zero-valent iron comprises a plate shape, a solid spherical shape, a porous structure, or a combination thereof.

14. The preparing method of claim 9, wherein the catalyst comprises metals or metal oxides.

15. The preparing method of claim 9, wherein a mean particle diameter of the precursor slurry is less than 10 μm.

16. The preparing method of claim 9, wherein based on a total amount of the precursor slurry, a content of the phosphoric acid aqueous solution in the precursor slurry is between 70 wt % and 90 wt %, a content of the zero-valent iron in the precursor slurry is between 1 wt % and 27 wt %, and a content of the catalyst in the precursor slurry is between 0.001 wt % and 3 wt %.

17. The preparing method of claim 16, wherein the content of the catalyst is about 0.1% to 10% of the content of the zero-valent iron.

18. The preparing method of claim 9, wherein the first component comprises lithium hydroxide, lithium carbonate, or a combination thereof.

19. The preparing method of claim 9, wherein the second component comprises carbon-based materials, organic compounds having a molecular weight less than 10,000, organic compounds having a molecular weight greater than 10,000, or a combination thereof.

20. The preparing method of claim 9, wherein based on 100 parts by weight of the precursor slurry, an amount of the first component ranges from 0.4 parts by weight to 20.8 parts by weight, and an amount of the second component ranges from 0.01 parts by weight to 15 parts by weight.
